(19) United States
(12) Patent Application Publication
(10) Pub. No.: US 2013/0333619 A1
(43) Pub. Date: Dec. 19, 2013

(54) ORGANIC THIN FILM FORMING APPARATUS

(71) Applicant: ULVAC, Inc., Chigasaki-shi (JP)

(72) Inventors: Daisuke OMORI, Tsukuba-shi (JP); Kazuya UCHIDA, Tsukuba-shi (JP); Jun MIYAUCHI, Chigasaki-shi (JP)

(73) Assignee: ULVAC, Inc., Chigasaki-shi (JP)

(21) Appl. No.: 13/912,425

(22) Filed: Jun. 7, 2013

Related U.S. Application Data
(63) Continuation of application No. PCT/JP2011/077898, filed on Dec. 2, 2011.

(30) Foreign Application Priority Data
Dec. 9, 2010 (JP) 2010-274523

(51) Int. Cl. B05C 11/00

(52) U.S. Cl. CPC B05C 11/00
USPC 118/723 R; 118/715

(57) ABSTRACT

An organic thin film forming apparatus that can easily remove an organic thin film adhered to a surface of a deposition preventive plate. The apparatus forms an organic thin film on a substrate disposed on a surface of a substrate stage from an organic gas. An electroless nickel film containing fluorine resin is formed on the surface of a deposition preventive plate. The electroless nickel film containing fluorine resin has mold release characteristics for an organic thin film. Even if the organic thin film adheres, the organic thin film can be easily removed by a method (such as, high pressure cleaning).

This application is a continuation of International Application No. PCT/JP2011/077898, filed Dec. 2, 2011, which claims priority of Japan Patent Application No. 2010-274523, filed on Dec. 9, 2010. The contents of the prior applications are herein incorporated by reference in their entireties.

### BACKGROUND

The present invention generally relates to an organic thin film forming apparatus. More particularly, the present invention relates to a technical field where an organic gas is supplied in a vacuum chamber and the organic gas causes a polymerization reaction on a surface of a substrate so as to form an organic thin film.

Currently, most organic thin films made of an organic macromolecular material are formed by a vapor deposition polymerization and an ultraviolet curing method. In both the vapor deposition polymerization method and the ultraviolet curing method, an organic gas having low-molecular-weight is supplied in a vacuum chamber, the organic gas causes a polymerization reaction on a surface of a substrate to form an organic macromolecular thin film. These methods feature high covering ability of the organic thin film.

In the conventional organic thin film forming apparatus (as shown in FIG. 3a), in order to prevent an adhesion of the organic thin film to an inner wall surface of a vacuum chamber 111, a deposition preventive plate 141 is held by a support (a bracket) 142 fixed on the inner wall surface of the vacuum chamber 111. However, since a gap is formed between the inner wall surface and the deposition preventive plate 141 in the vapor deposition polymerization method and the ultraviolet curing method, an organic gas leaks into this gap. Thus, the adhesion of the organic thin film to the inner wall surface of the vacuum chamber 111 cannot be prevented.

Furthermore, it is difficult to peel off an organic thin film adhered to the inside of the conventional organic thin film forming apparatus. The organic thin film is removed by a blasting process or a method where the organic thin film comes into contact with acid or alkali chemicals. However, the base material is deformed by the blasting process, and when the surface treatment is performed to the base material, the surface treatment is peeled off; and thus, the surface treatment has to be performed again. As such, the increase in cost becomes a problem. Furthermore, the base material may be dissolved by a method where the organic thin film comes into contact with acid or alkali chemicals.
Patent Literature 1: Japanese Patent No. 4112702

### SUMMARY OF THE INVENTION

The present invention has been made to solve the inconvenience of the above-described conventional technique; and it is an object of the present invention to provide an organic thin film forming apparatus that can easily remove an organic thin film adhered to a surface of a deposition preventive plate.

To solve the above-described problems, an organic thin film forming apparatus of the present invention includes a vacuum chamber; a substrate stage disposed in the vacuum chamber; a gas supply portion that supplies an organic gas from a supply port exposed in the vacuum chamber to an inside of the vacuum chamber; and a deposition preventive plate mounted to an inner wall surface of the vacuum chamber. The apparatus of the present invention for forming an organic thin film on a substrate disposed on a surface of the substrate stage from the organic gas characterized in that an electroless nickel film containing fluorine resin is formed on an exposed surface of the deposition preventive plate, and the electroless nickel film containing fluorine resin contains polytetrafluoroethylene of a volume rate of 20% or more to 40% or less with respect to a volume of an entire of the film.

In the organic thin film forming apparatus of the present invention, a back surface of the deposition preventive plate, which is opposite to the surface of the deposition preventive plate, is fixed in close contact with an inner wall surface of the vacuum chamber.

In the organic thin film forming apparatus of the present invention, the deposition preventive plate includes a base material made of at least one kind of metals selected from the group consisting of an iron, a stainless steel, a copper alloy, and an aluminum.

In the organic thin film forming apparatus of the present invention, the electroless nickel film containing fluorine resin is formed on a surface of the supply port.

In the organic thin film forming apparatus of the present invention, the electroless nickel film containing fluorine resin is formed at a part around the substrate on a surface of the substrate stage.

The organic thin film forming apparatus of the present invention further includes at least two of the gas supply portions.

In the organic thin film forming apparatus of the present invention the organic thin film is a thin film made of polyuria.

The organic thin film forming apparatus of the present invention further includes an ultraviolet lamp for emitting ultraviolet rays disposed at a position facing a surface of the substrate stage.

In the organic thin film forming apparatus of the present invention, the organic thin film is a thin film made of an ultraviolet light curable type acrylic.

Because an organic thin film adhered to a deposition preventive plate can be easily removed by the above-explained method (such as, high pressure cleaning), labor and time needed to clean the work can be reduced. Further, when removing the work of the organic thin film, an electroless nickel film containing fluorine resin is not damaged. Therefore, there is no increase in cost when replacing the deposition preventive plate.

### BRIEF DESCRIPTION OF THE DRAWINGS

FIG. 1 is an internal configuration view showing a first example of an organic thin film forming apparatus of the present invention.

FIG. 2 is an internal configuration view showing a second example of an organic thin film forming apparatus of the present invention.

FIGS. 3a and 3b are enlarged cross-sectional views of a chamber wall of a vacuum chamber and a deposition preventive plate; FIG. 3a shows a conventional apparatus, while FIG. 3b shows the apparatus of the present invention.

FIG. 4 is a plan view of an end portion of a pipe inserted in the vacuum chamber.

### DETAILED DESCRIPTION OF THE INVENTION

### <Structure of the First Example of the Organic Thin Film Forming Apparatus>

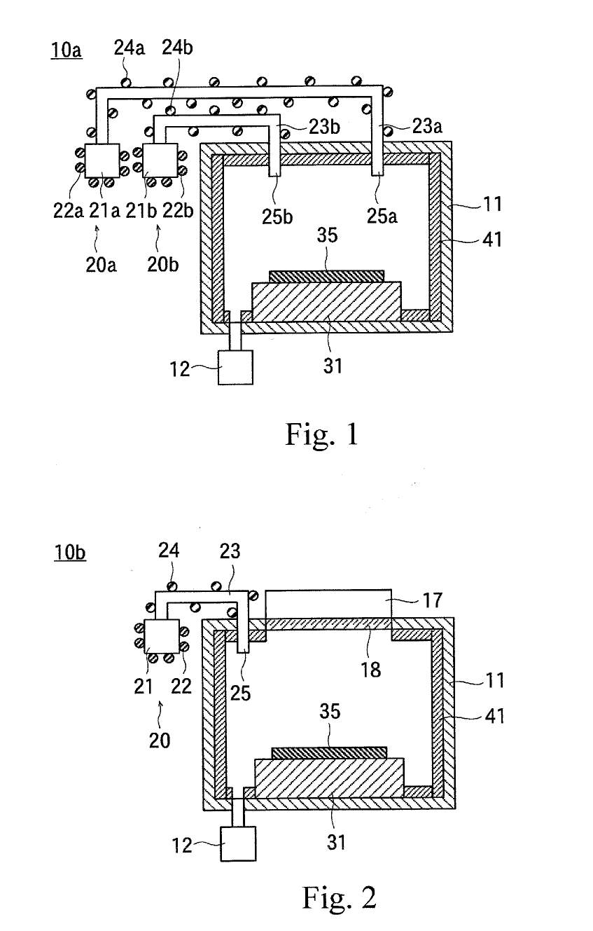

A description will be given of a structure of a first example of the organic thin film forming apparatus according to the present invention. FIG. 1 is an internal configuration view showing a first example of the organic thin film forming apparatus 10a.

The first example of the organic thin film forming apparatus 10a includes a vacuum chamber 11, a substrate stage 31 disposed in the vacuum chamber 11, and a first and a second gas supply portions 20a and 20b supplying an organic gas from a first and a second supply ports 25a and 25b exposed in the vacuum chamber 11 to the vacuum chamber 11. A vacuum evacuation device 12 is connected to the wall surface of the vacuum chamber 11 so as to vacuum evacuate the inside of the vacuum chamber 11.

A position where a substrate is to be disposed is preliminarily determined on a surface of the substrate stage 31 and the substrate stage 31 is disposed in the vacuum chamber 11 with the surface exposed. Reference numeral 35 denotes a substrate disposed at the predetermined position on the surface of the substrate stage 31.

The first and second gas supply portions 20a and 20b include first and second house containers 21a and 21b for containing a solid or liquid organic material, first and second heating devices 22a and 22b for heating the contained organic material, and first and second pipes 23a and 23b of which one end of each of the first and second pipes 23a and 23b is connected inside each of the first and second house containers 21a and 21b; and the other ends are inserted into the vacuum chamber 11. The first and second supply ports 25a and 25b are openings disposed at the end portions, which are inserted into the vacuum chamber 11, of the first and second pipes 23a and 23b. The first and second supply ports 25a and 25b are exposed in the vacuum chamber 11.

FIG. 4 shows a plan view of the end portions of the first and second pipes 23a and 23b inserted in the vacuum chamber 11. In this embodiment, the first and second supply ports 25a and 25b are constituted of a plurality of small diameter holes like a shower head. However, the present invention is not limited to this, and the first and second supply ports 25a and 25b may have another shape.

The first and second house containers 21a and 21b are disposed outside of the vacuum chamber 11. The first and second house containers 21a and 21b contain first and second organic materials, which are materials of an organic thin film. Materials which can form the organic thin films by a co-deposition polymerization reaction when the vapors arrive on a substrate 35, are employed as the first and the second organic materials.

The first and second heating devices 22a and 22b are resistance heating devices each having a liner-shape. The first and second heating devices 22a and 22b are wound around the outer periphery of the first and second house containers 21a and 21b. The first and second heating devices 22a and 22b heat the first and second organic materials in the first and second house containers 21a and 21b so as to evaporate them. Hereinafter, vapors of the first and second organic materials are referred to as first and second organic gases.

The first and second organic gases generated in the first and second house containers 21a and 21b pass through the inside of the first and second pipes 23a and 23b; and then, the first and second organic gases are emitted from the first and second supply ports 25a and 25b, which are exposed in the vacuum chamber 11, to the vacuum chamber 11.

First and the second pipe heaters 24a and 24b are wound around the first and second pipes 23a and 23b. The first and second pipes 23a and 23b are heated to a temperature higher than a condensation temperature of the first and second organic gases in a manner such that the first and second organic gases passing through the inside do not condense on the wall surfaces of the first and second pipes 23a and 23b.

A deposition preventive plate 41 is fixed in close contact with the inner wall surface of the vacuum chamber 11. The base material of the deposition preventive plate 41 is made of at least one kind of metal selected from the group consisting of an iron, a stainless steel, a copper alloy, and an aluminum. An electroless nickel film containing fluorine resin is formed on an exposed surface of the deposition preventive plate 41. The electroless nickel film containing fluorine resin contains polytetrafluoroethylene (PTFE) of a volume rate in the range of between at least 20% and at most 40% with respect to a volume of the entire film. In this embodiment, “NIFGRIP” (registered trademark) of ULVAC TECHNO, Ltd. is used.

A description will be given for a formation method of the electroless nickel film containing fluorine resin. The deposition preventive plate 41 with the base material exposed on the surface is soaked into the electroless nickel plating solution where PTFE is dispersed. Then, nickel and PTFE are co-deposited on the surface of the deposition preventive plate 41. Next, the deposition preventive plate 41 is heat-treated at 380° C. to 400° C. in air atmosphere so as to strongly adhere to the electroless nickel and PTFE.

The electroless nickel film containing fluorine resin has mold release characteristics to an organic thin film. Even if the organic thin film adheres, the organic thin film can be easily removed by a method (such as, high pressure cleaning) without damaging the electroless nickel film containing fluorine resin. If the organic thin film is continually laminated on the surface of the deposition preventive plate 41, the surface part of the laminated film may peel off, and the peeled impurities may adhere to the surface of the substrate 35. The removal of the organic thin film before the generation of peeling can prevent this problem.

Additionally, the electroless nickel film containing flourine resin is excellent for an adhesive property to the base material, and is therefore not peeled off from the base material when the organic thin film is removed. Accordingly, the cost for re-forming the electroless nickel film containing fluorine resin after removal of the organic thin film is unnecessary.

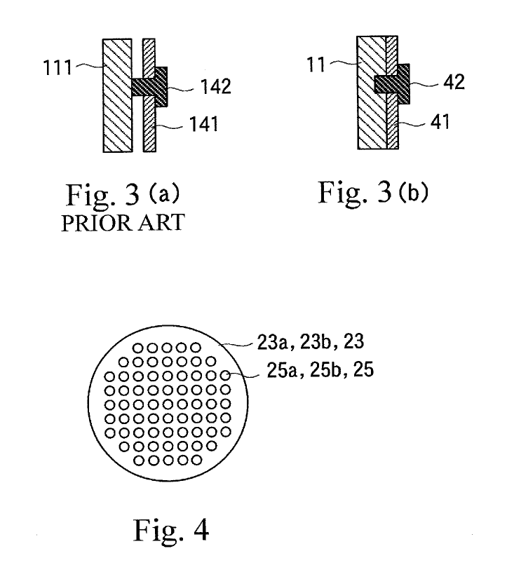

FIG. 3b is an enlarged cross-sectional view of the chamber wall of the vacuum chamber 11 and the deposition preventive plate 41. In this embodiment, the deposition preventive plate 41 is fastened to the vacuum chamber 11 with a screw-shaped fixture 42. A back surface, which is opposite to the surface of the deposition preventive plate 41, is fixed in close contact with the inner wall surface of the vacuum chamber 11. Therefore, the first and second organic gases, which are supplied in the vacuum chamber 11, do not go into and between the back surface of the deposition preventive plate 41 and the inner wall surface of the vacuum chamber 11 so that forming the organic thin film on the inner wall surface of the vacuum chamber 11 is prevented.

In this embodiment, in the first and second pipes 23a and 23b, the base material of the first and second supply ports 25a and 25b are also made of one kind or more kinds of materials selected from the group consisting of an iron, a stainless steel, a copper alloy, and an aluminum. The electroless nickel film containing fluorine resins are also formed on the surfaces of the first and second supply ports 25a and 25b. Accordingly, even if the organic thin films are formed on the surfaces of the first and second supply ports 25a and 25b, the organic thin film can be easily removed by a method (such as, high pressure cleaning) without damaging the electroless nickel film containing fluorine resin.

Accordingly, even if the first and second supply ports 25a and 25b have a small hole and therefore tend to be obstructed by the formation of an organic thin film, the removal of the organic thin film before obstruction prevents the reduction of a supply flow rate of the first and second organic gases.

Furthermore, in the surface of the substrate stage 31, a base material of a part around the predetermined position where the substrate 35 is to be disposed is also made of at least one kind of material selected from the group consisting of an iron, a stainless steel, a copper alloy, and an aluminum. The electroless nickel film containing fluorine resin is also formed on the surface of the substrate stage 31. Accordingly, when an organic thin film is formed on the surface of the substrate 35, in the surface of the substrate stage 31, the organic thin film is also formed at the part around the position where the substrate 35 is to be disposed. However, the organic thin film can be easily removed by a method (such as, high pressure cleaning) without damaging the electroless nickel film containing fluorine resin.

### <Formation Method of the First Example of the Organic Thin Film>

A description will be given of a method for forming an organic thin film using the first example of the organic thin film forming apparatus 10a.

### (Deposition Process)

The vacuum chamber 11 is vacuum evacuated by the vacuum evacuation device 12 so as to form a vacuum ambience inside the vacuum chamber 11. Hereinafter, vacuum evacuation is continuously performed to maintain a vacuum ambience. The substrate 35 is carried in the vacuum chamber 11 while maintaining the vacuum ambience in the vacuum chamber 11. On the surface of the substrate stage 31, the substrate 35 is disposed at the predetermined position where its peripheral area is surrounded by the electroless nickel film containing fluorine resin.

The first and second organic materials are disposed inside of the first and second house containers 21a and 21b. In this embodiment, as a first organic material, 1,12-Dodecanediamine, which is a diamine, is used. As a second organic material, 1,3-Bis (isocyanatomethyl)cyclohexane, which is diisocyanate, is used. However, the first and second organic materials are not limited to these materials insofar as they cause a co-deposition polymerization reaction on the substrate 35. For example, 4,4′-Diaminodiphenylmethane (MDA), which is a diamine, and 4,4′-Diphenylmethane diisocyanate (MDI), which is a diisocyanate, may be used.

The first and second pipes 23a and 23b are heated to a temperature higher than a condensation temperature of the first and second organic gases by the first and second pipe heaters 24a and 24b. When the first and second organic materials are heated by the first and second heating devices 22a and 22b, the first and second organic gases are generated from the first and second organic materials. The generated first and second organic gases are supplied from the first and second supply ports 25a and 25b to the inside the vacuum chamber 11 through the inside of the first and second pipes 23a and 23b.

The supplied first and second organic gases cause a co-deposition polymerization reaction on the surface of the substrate 35; and the organic thin film is formed on the surface of the substrate 35. In this embodiment, a thin film of polyurea is formed. A part of the first and second organic gases supplied in the vacuum chamber 11 also causes a co-deposition polymerization reaction on the surface of the deposition preventive plate 41. Accordingly, the organic thin film is also formed on the surface of the deposition preventive plate 41.

Furthermore, a part of the first and second organic gases also causes a co-deposition polymerization reaction on the surfaces of the first and second supply ports 25a and 25b, and at a part around the substrate 35 in the surface of the substrate stage 31 to form the organic thin film at the respective positions. After the organic thin film having a predetermined film thickness is formed on the surface of the substrate 35, the supply of the first and second organic gases from the first and second supply ports 25a and 25b is stopped. The film-formed substrate 35 is carried out of the vacuum chamber 11; another substrate 35 to be film-formed is carried in the vacuum chamber 11; and the above-described deposition process is repeated while vacuum ambience in the vacuum chamber 11 is maintained.

(Cleaning Process)

A preliminary test and simulation are performed so as to determine the number of substrates that can be continuously deposited before the organic thin films laminated at a part other than the substrate 35 begin to peel off and before the first and second supply ports 25a and 25b are obstructed by the organic thin films. After the organic thin films are formed on the predetermined number of substrates 35, where the number was determined by the preliminary test and simulation, a cleaning process is performed on the first example of the organic thin film forming apparatus 10a.

After the substrate 35 is carried out of the vacuum chamber 11, the vacuum evacuation device 12 is stopped, and the vacuum chamber 11 is opened to the aid atmosphere. Then, the deposition preventive plate 41 is removed from the inner wall surface of the vacuum chamber 11 and taken out of the vacuum chamber 11. In the inner wall surface of the vacuum chamber 11, the organic thin film is not formed at a part where the deposition preventive plate 41 is fixed.

When a high pressure cleaning process, which sprays water at high pressure, is performed over the removed deposition preventive plate 41, because the electroless nickel film containing fluorine resin is preliminary formed on the surface of the deposition preventive plate 41, the organic thin film is easily removed. It is noted that a method for removing the organic thin film is not limited to the high pressure cleaning process. For example, the organic thin film can be removed using a tool (such as, tweezers). However, the high pressure cleaning process is preferred because the high pressure cleaning process is less likely to damage the electroless nickel film containing fluorine resin compared to other methods.

Further, the end portions of the first and second pipes 23a and 23b at the first and second supply ports 25a and 25b side are taken out from the vacuum chamber 11. The organic thin film is removed by a method (such as, a high pressure cleaning process). Because the electroless nickel film containing fluorine resin is preliminary formed on the surfaces of the first and second supply ports 25a and 25b, the organic thin film is easily removed.

Furthermore, the substrate stage 31 is taken out from the vacuum chamber 11, and the organic thin film is removed by a method (such as, a high pressure cleaning process). Because the electroless nickel film containing fluorine resin is also formed at a part around the predetermined position, where the substrate 35 is to be disposed, on the surface of the substrate stage 31, the organic thin film is easily removed.

The cleaned substrate stage 31 is brought into the vacuum chamber 11 and installed at the predetermined position. The end portions of the cleaned first and second pipes 23a and 23b at the first and second supply ports 25a and 25b side are inserted in the vacuum chamber 11 and sealed in an airtight manner. The cleaned deposition preventive plate 41 is installed in the vacuum chamber 11 and fixed in close contact with the inner wall surface of the vacuum chamber 11.

Next, the above-discussed deposition process is resumed. The organic thin films laminated at a part other than the substrate 35 are removed. Accordingly, a problem in which the peeled organic thin film adheres as an impurity to the substrate does not occur. Because the first and second supply ports 25a and 25b are not obstructed by the organic thin film, the first and second organic gases can be supplied at a constant flow rate, and the organic thin film having a constant film quality can be formed on the substrate 35.

### <Structure of the Second Example of the Organic Thin Film Forming Apparatus>

A description will be given of a structure of a second example of an organic thin film forming apparatus according to the present invention. FIG. 2 is an internal configuration view showing a second example of an organic thin film forming apparatus 10b. The second example of the organic thin film forming apparatus 10b will now be described wherein the same reference numerals designate corresponding or identical structure descriptions with the above-discussed first example of the organic thin film forming apparatus 10a throughout the embodiments.

The second example of the organic thin film forming apparatus 10b includes the vacuum chamber 11, the substrate stage 31 disposed in the vacuum chamber 11, and a gas supply portion 20. The gas supply portion 20 supplies an organic gas from a supply port 25 in the vacuum chamber 11. The supply port 25 is exposed in the vacuum chamber 11.

In other words, the second example of the organic thin film forming apparatus 10b includes one gas supply portion 20 instead of the first and second gas supply portions 20a and 20b of the above-discussed first example of the organic thin film forming apparatus 10a. Additionally, the second example of the organic thin film forming apparatus 10b includes an ultraviolet lamp 17 that emits ultraviolet rays.

A description of a part that has the same structure as that of the first example of the organic thin film forming apparatus 10a is omitted. The gas supply portion 20 includes a house container 21 which can contain solid or liquid organic material, a heating device 22, and a pipe 23 for heating contained organic material; and one end of the pipe 23 is connected to the container 21 and the other end is inserted in the vacuum chamber 11.

An opening at the end portion of the pipe 23 inserted in the vacuum chamber 11 is referred to as the supply port 25. The supply port 25 is exposed in the vacuum chamber 11. In this embodiment, in reference to FIG. 4, a number of small diameter holes like a shower head constitute the supply port 25. However, the present invention is not limited to this shape and the supply port 25 may have other shapes.

The house container 21 is disposed outside of the vacuum chamber 11. The house container 21 houses an organic material, which is a material of an organic thin film. A material, which can form an organic film by irradiating ultraviolet rays on the film having liquid form for curing, is used as an organic material.

Here, the heating device 22 is a linear resistance heating device. The heating device 22 is wound around the outer periphery of the house container 21 so as to heat the organic material in the house container 21 to be evaporated. Hereinafter, a vapor of the organic material is referred to as an organic gas. The organic gas generated in the house container 21 passes through the inside of the pipe 23; and the organic gas is then emitted from the supply port 25, which is exposed in the vacuum chamber 11, to the inside of the vacuum chamber 11.

A pipe heater 24 is wound around the pipe 23. The pipe 23 is heated to a temperature higher than a condensation temperature of the organic gas in a manner such that the organic gas passing through the inside of the pipe 23 is not deposited at the wall surface of the pipe 23. A transmissive window 18, which transmits ultraviolet rays, is disposed at a part facing the surface of the substrate stage 31 in the chamber wall of the vacuum chamber 11. The material of the transmissive window 18 is, for example, quartz.

The ultraviolet lamp 17 is disposed at a position facing the transmissive window 18 outside of the vacuum chamber 11. When ultraviolet rays are emitted from the ultraviolet lamp 17, the emitted ultraviolet rays transmit through the transmissive window 18 and irradiate the inside of the vacuum chamber 11. In this embodiment, the ultraviolet lamp 17 is disposed outside the vacuum chamber 11; however, the ultraviolet lamp 17 may be disposed inside of the vacuum chamber 11, and the transmissive window 18 may be omitted. In addition, the ultraviolet lamp 17 may still be at the position facing the surface of the substrate stage 31 or may be configured so as to reciprocate within a planar surface facing the surface of the substrate stage 31. The deposition preventive plate 41 is mounted to be in close contact with the inner wall surface of the vacuum chamber 11. Because the structure of the deposition preventive plate 41 is the same as the structure of the deposition preventive plate 41 of the first example of the organic thin film forming apparatus 10a, the description thereof is omitted here.

In this embodiment, in the pipe 23, the structure of a part of the supply port 25 is the same as the structure of the parts of the first and second supply ports 25a and 25b of the first and second pipes 23a and 23b in the first example of the organic thin film forming apparatus 10a; therefore, the description thereof is omitted here. Furthermore, in the surface of the substrate stage 31, a structure of a part around the predetermined position where the substrate 35 is to be disposed is also the same as the structure of the substrate stage 31 of the first example of the organic thin film forming apparatus 10a; therefore, the description thereof is omitted here.

### <Formation Method of the Second Example of the Organic Thin Film>

A description will be given of a method for forming an organic thin film using the second example of the organic thin film forming apparatus 10b of the present invention.

### (Deposition Process)

The vacuum chamber 11 is vacuum evacuated by the vacuum evacuation device 12 so as to form a vacuum ambience inside the vacuum chamber 11. Hereinafter, vacuum evacuation is continuously performed to maintain a vacuum ambience.

The substrate 35 is carried into the vacuum chamber 11 while maintaining the vacuum ambience in the vacuum chamber 11. On the surface of the substrate stage 31, the substrate 35 is disposed at a predetermined position where its peripheral area is surrounded by the electroless nickel film containing fluorine resin. The organic material is disposed inside of the house container 21. In this embodiment, as a type of organic material, an ultraviolet light curable acrylic monomer or oligomer is employed. A photopolymerization reaction initiator may be added to the organic material.

The pipe 23 is heated to a temperature higher than a condensation temperature of the organic gas by the pipe heater 24. When the organic material is heated by the heating device 22, the organic gas is generated from the organic material. The generated organic gas is supplied from the supply port 25 to the inside of the vacuum chamber 11 through the inside of the pipe 23.

The supplied organic gas adheres to the surface of the substrate 35 and condenses, thus forming a film having liquid form. Furthermore, a part of the organic gas also adheres to the surface of the deposition preventive plate 41 and condenses, thus forming a film having liquid form. Moreover, a part of the organic gas also adheres to the surface of the supply port 25 and a part around the substrate 35 on the surface of the substrate stage 31 and condenses, thus forming a film having liquid form.

After the liquid film having a predetermined thickness is formed on the surface of the substrate 35, supply of the organic gas from the supply port 25 is stopped. Ultraviolet rays are emitted from the ultraviolet lamp 17 while maintaining a vacuum ambience in the vacuum chamber 11. The emitted ultraviolet rays transmit through the transmissive window 18 and penetrate inside the vacuum chamber 11. A part of the ultraviolet rays, which penetrates the vacuum chamber 11, is incident on the surface of the substrate 35. This causes a photopolymerization reaction to the liquid film, which is made of an organic material formed on the surface of the substrate 35, so as to harden. Thus, an organic thin film is formed on the surface of the substrate 35. In this embodiment, a thin film made of an acrylic resin is formed.

A part of the ultraviolet rays irradiated on the surface of the deposition preventive plate 41 causes a photopolymerization reaction of the liquid film, which is made of an organic material, formed on the surface of the deposition preventive plate 41 so as to harden the liquid film. Thus, an organic thin film is also formed on the surface of the deposition preventive plate 41. Furthermore, a part of the ultraviolet rays penetrating the vacuum chamber 11 also irradiate on the surface of the supply port 25 and a part around the substrate 35 on the surface of the substrate stage 31. This causes a polymerization reaction of the liquid films, which are made of an organic material, formed at the respective positions, to harden the liquid films. Thus, organic thin films are formed at the respective positions.

After the organic thin film is formed on the surface of the substrate 35, emission of the ultraviolet rays from ultraviolet lamp 17 is stopped. The film-formed substrate 35 is carried out of the vacuum chamber 11; another substrate 35 to be film-formed is carried in the vacuum chamber 11; and the above-described deposition process is repeated, while vacuum ambience in the vacuum chamber 11 is maintained.

(Cleaning Process)

A preliminary test and a simulation are performed in order to determine the number of substrates that can be continuously deposited before the organic thin films laminated at a part other than the substrate 35 begin to peel off and before the supply port 25 is obstructed by the organic thin films.

After the organic thin films are formed on the predetermined number of the substrates 35 of which the number of the substrates is preliminarily obtained, the cleaning process is performed on the second example of the organic thin film forming apparatus 10b. Because the cleaning process of the second example of the organic thin film forming apparatus 10b is similar to the cleaning process of the first example of the organic thin film forming apparatus 10a, the description thereof is omitted here.

The first and second examples of organic thin film forming apparatuses 10a and 10b may include a heater (not shown) that heats a peripheral part around a predetermined position where the substrate 35 is to be disposed among the surface of the deposition preventive plate 41, the surfaces of the first and second supply ports 25a and 25b or the surface of the supply port 25, and the surface of the substrate stage 31.

Before supplying the organic gas in the vacuum chamber 11, the peripheral part around a predetermined position where the substrate 35 is to be disposed on the surface of the substrate stage 31 are heated to a temperature higher than a condensation temperature of the organic gas by the heater (not shown) among the surface of the deposition preventive plate 41, the surfaces of the first and second supply ports 25a and 25b or the surface of the supply port 25, and the surface of the substrate stage 31. This reduces an amount of adhered organic gas itself, and allows an increase in the number of substrates that can be continuously deposited before the cleaning process. In FIG. 1 and FIG. 2, a deposition set, which includes the substrate stage 31 and the supply ports 25a and 25b or 25, only one set is disposed in the vacuum chamber 11. The present invention is not limited to this structure and the deposition set may be disposed with two sets or more. When the second example of the organic thin film forming apparatus 10b includes at least two sets of the deposition sets, one ultraviolet lamp 17 moves to a position facing the surface of each of substrate stage 31 is preferred in terms of being low in cost compared to different ultraviolet lamps 17 disposed at the respective deposition sets. When the second example of the organic thin film forming apparatus 10b includes at least two sets of the deposition sets, while a photoactive organic material adheres to the surface of one substrate 35 with one deposition set, performing a light irradiation on the surface of the other substrate 35 by the other deposition set improves production efficiency of the organic thin film.

### DESCRIPTION OF REFERENCE SIGNS

10a, 10b organic thin film forming apparatus
11 vacuum chamber
20a, 20b, 20 gas supply portion
25a, 25b, 25 supply port
31 substrate stage
35 substrate
41 deposition preventive plate

What is claimed is:

1. An organic thin film forming apparatus, comprising:
a vacuum chamber;
a substrate stage disposed in the vacuum chamber;
a gas supply portion that supplies an organic gas from a supply port exposed in the vacuum chamber to an inside of the vacuum chamber; and
a deposition preventive plate mounted to an inner wall surface of the vacuum chamber,
wherein the apparatus forms an organic thin film on a substrate disposed on a surface of the substrate stage from the organic gas,
wherein an electroless nickel film containing fluorine resin is formed on an exposed surface of the deposition preventive plate, and
wherein the electroless nickel film containing fluorine resin contains polytetrafluoroethylene of a volume rate of between at least 20% and at most 40% with respect to a volume of an entire of the film.

2. The organic thin film forming apparatus according to claim 1, wherein a back surface of the deposition preventive plate, which is opposite to the surface of the deposition preventive plate, is fixed to be in close contact with an inner wall surface of the vacuum chamber.

3. The organic thin film forming apparatus according to claim 1, wherein the deposition preventive plate includes a base material made of at least one kind of metal selected from the group consisting of an iron, a stainless steel, a copper alloy, and an aluminum.

4. The organic thin film forming apparatus according to claim 1, wherein the electroless nickel film containing fluorine resin is formed on a surface of the supply port.

5. The organic thin film forming apparatus according to claim 1,
wherein the electroless nickel film containing fluorine resin is formed at a part around the substrate on a surface of the substrate stage.

6. The organic thin film forming apparatus according to claim 1, further comprising at least two of the gas supply portions.

7. The organic thin film forming apparatus according to claim 6, wherein the organic thin film is a thin film made of polyuria.

8. The organic thin film forming apparatus according to claim 1, further comprising an ultraviolet lamp for emitting ultraviolet rays disposed at a position facing a surface of the substrate stage.

9. The organic thin film forming apparatus according to claim 8, wherein the organic thin film is a thin film made of an ultraviolet light curable type acrylic resin.
